(19) United States
(12) Patent Application Publication
(10) Pub. No.: US 2003/0028721 A1
(43) Pub. Date: Feb. 6, 2003

(54) Method and apparatus for creating a media identifier and indexing a media products database

(75) Inventor: Mark L. Woodward, Milton, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: DotClick Corporation, Boston, MA

(21) Appl. No.: 10/209,192

(22) Filed: Jul. 30, 2002

Related U.S. Application Data
(60) Provisional application No. 60/309,123, filed on Jul. 31, 2001.

(51) Int. Cl. G06F 12/00

(52) U.S. Cl. 711/112; 711/111

(57) ABSTRACT

The present invention teaches a method for creating a media identifier by reading media comprising tracks and a table of contents, the table of contents comprising a beginning track offset for each of the tracks. A bitmap is calculated comprising a series of bits, each bit representing the results of each pair-wise comparison of lengths of a pair of tracks recorded on the media. The media can be an audio CD having pairs of adjacent tracks. A one-bit in the bitmap can indicate that a length of a current track is longer than a length of an associated track and a zero-bit in the bitmap indicates that the length of the current track is shorter than or equal to the length of the associated track. Other identifiers are created by calculating the total number of tracks with differing lengths, the average absolute difference of lengths of the tracks recorded on the media, the minimum absolute difference of lengths of the tracks recorded on the media, and the maximum absolute difference of lengths of tracks recorded on the media. The identifiers are used to index a database of records containing information about recorded media products. Using the identifier, a subset of records in the database is identified. The identified records are searched for a most likely match of media identifier to database record.

### RELATED APPLICATION(S)

This application claims the benefit of U.S. Provisional Application No. 60/309,123 filed on Jul. 31, 2001. The entire teachings of the above application are incorporated herein by reference.

### BACKGROUND OF THE INVENTION

This invention relates generally to identifying media and more specifically to creating a media identifier by reading media comprising tracks and a table of contents.

Many common music CDs do not have identifying information on them. That is, the CD only contains music, no information about the name of the artist, publisher, or tracks. For a system to display track information during play, some external source of this extra information must be present.

### SUMMARY OF THE INVENTION

The present invention teaches a method for creating a media identifier by reading media comprising tracks and a table of contents, the table of contents comprising a beginning track offset for each of the tracks. A bitmap is calculated comprising a series of bits, one bit representing the results of each pair-wise comparison of lengths of a pair of tracks recorded on the media. In one preferred embodiment, the media is an audio CD and the pair of tracks is formed of adjacent tracks. In another preferred embodiment, a one-bit in the bitmap indicates that a length of a current track is longer than a length of an associated track and a zero-bit in the bitmap indicates that the length of the current track is shorter than or equal to the length of the associated track.

Other identifiers are created by calculating the total number of tracks with differing lengths, the average absolute difference of lengths of the tracks recorded on the media, the minimum absolute difference of lengths of the tracks recorded on the media, and the maximum absolute difference of lengths of tracks recorded on the media. Additionally, identifiers based on arithmetic metrics include average absolute difference, standard deviation of track length, or average square of differences.

The identifiers are used to index a database of records containing information about recorded media products by using the identifier to identify a subset of records in the database and searching the identified records for a most likely match of media identifier to database record.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 illustrates a networked system on which an embodiment of the present invention is implemented.

FIG. 2 is a diagram of the internal structure of a node connected to the networked system of FIG. 1 configured according to an embodiment of the present invention.

FIG. 3 is a diagram of the layout of an audio CD configured according to an embodiment of the present invention.

FIG. 4 illustrates a Table of Contents (TOC) for an audio CD configured according to an embodiment of the present invention.

FIG. 5A is a table of data for example tracks stored on a CD configured according to an embodiment of the present invention.

FIG. 5B is a table of identifiers calculated for an example CD configured according to an embodiment of the present invention.

### DETAILED DESCRIPTION OF THE INVENTION

A description of preferred embodiments of the invention follows. Typically, the information that is available on the CD is nothing more than the offsets, on the CD, to the beginning of each track of music (each song), and the total length of all the music on the CD. According to the Red Book standard for medias, music on CDs is stored in frames, each frame comprising 1/75th of a second of music. So the typical offsets are large integers, and precisely represent the duration of the music recorded on the CD with a resolution of just over 13 milliseconds. From this data, the length of each track on the CD—each musical number—can be calculated in hours, minutes, and seconds. This calculation is fully documented in published standards and is public knowledge (see General information on CDs: http://www.disctronics.co.uk/).

Methods for computing approximate lengths of songs on CDs, and using an approximate matching technique to extract one or more particular records from a database matching the particular song, are known. The technique of the present invention has similar intent, but relies on precise, rather than approximate, comparisons between track durations.

Music companies store and publish information about their CD products, including the durations of songs. This information is available printed on CD liner notes, silk-screened onto CDs, and in the corporate information systems of music publishing companies. By performing a match of the precise track lengths in published track duration data to the precisely calculated track lengths from the CD, a list of likely matches can be created.

As those skilled in the art will appreciate, an extensive search of a large database for exact matches of a list of numbers is an inefficient and time-consuming operation. A less specific general indexing representation must be created—ideally a short “fingerprint” or “hash”—to accelerate retrieval. Certain methods of computing short hash codes for CDs, based on arithmetic functions applied to CD lengths are known in the art. Those skilled in the art understand that to be useful, such a fingerprint must be inexpensive to compute, inexpensive to store, and highly discriminating—highly likely to identify the correct item and highly unlikely to identify the wrong item.

The present invention incorporates an innovative fingerprint identifier that meets all these criteria for usefulness, and additionally is more discriminating than the prior art, especially in the most common practical situation. In this most common situation, the database is constructed from raw inputs including track times in hours, minutes, and seconds, whereas the sensing of tracks on actual CDs is done from raw inputs in 1/75th-second frames. Conventional fingerprint methods, to work properly, must take as input the raw lengths of the tracks in frames.

In the present invention, the relative differences between the lengths tracks are represented as a bitmap, where each successive bit represents the relationship of the prior song to the next. This bitmap is used as the fingerprint. If track 2 is longer than track 1, bit 2, in the bitmap, will be set to a logic value of 1. If track 3 is shorter than track 2, bit 3 in the bitmap will be set to a logic value 0. Bit 0, in the bitmap, will always be set to a 1 value since what ever the track length of track 0 is, it will be longer than the non-existent prior track (a null value). Alternately, track 1 information can be assumed. In this representation, we consider “bit 0” to be the leftmost, highest-order, bit in the hash. Those skilled in the art will appreciate that this allows the number of tracks to be represented implicitly in the fingerprint.

This bitmap represents a fingerprint of the characteristics of the music on the CD. Using this bitmap in an index allows a database system to locate and return a small subset of the total records in the music database which have similar fingerprints i.e., the same number of tracks and the same exact pattern of relative track lengths). This reduced number of records can easily be compared, second by second, for total program length, and for the length of each track on the CD against the information in the database, for an exact match.

The comparison of the information on the CD against the information in the database creates five numbers: the number of tracks with differing length in minutes and seconds, the average absolute difference, minimum absolute difference, and maximum absolute difference. The average difference is the sum of the differences between each track comparison, divided by the number of tracks. The minimum difference is the smallest difference between tracks. The maximum difference is the largest difference between tracks. Those skilled in the art will appreciate that differences between numbers can be computed efficiently in a variety of different statistical ways, including absolute values, sums of squares of differences, and so forth.

The closer the differences, from the comparison, are to zero, the better the match of the CD information to the information in the database.

This method compares exact track length information in an innovative fashion to pick one record from a plurality of records matching a single user-furnished CD with a plurality of CDs, exploiting published track lengths.

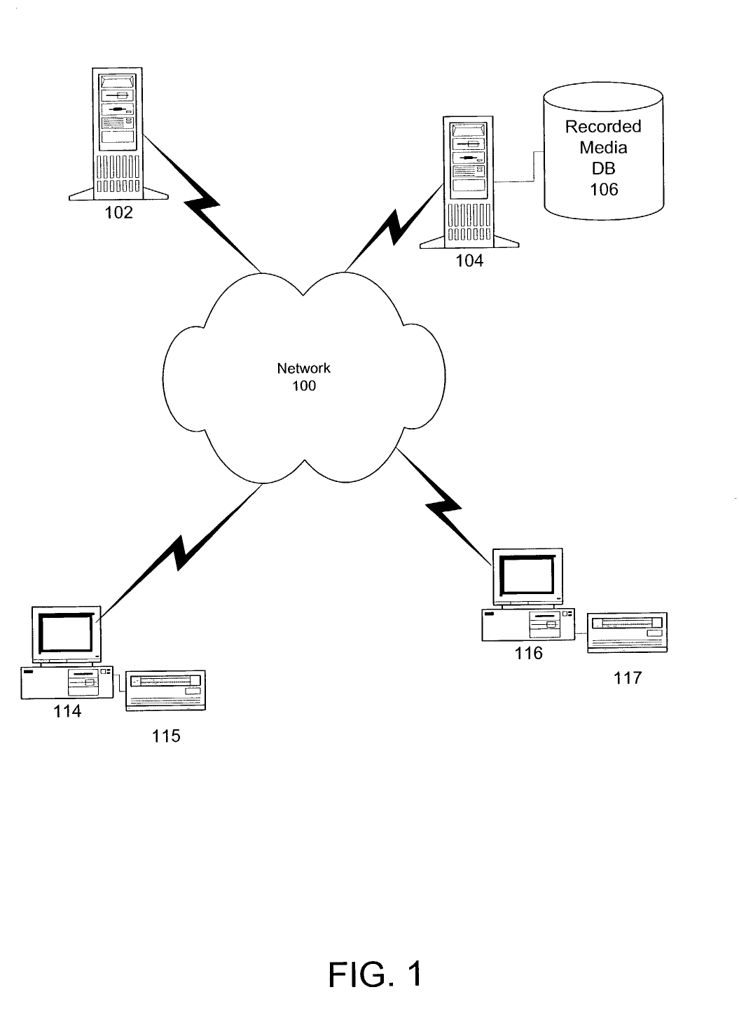

FIG. 1 illustrates a networked system on which an embodiment of the present invention is implemented. Network 100 connects various nodes, such as computers 114, 116 and servers 102, 104. Computers 114, 116 are connected to media reading devices 115 and 117, respectively. Media readers 115, 117 provide access to preformatted recorded media (e.g., an audio CD).

Servers 102, 104 are connected to network 100 and are accessible by computers 114, 116. Server 104 has access to recorded media DB 106 which stores records associated with various identified media products. The data contained in recorded media DB 106 includes, but is not limited to, media product name (e.g., CD name), number of tracks on the media product, names of tracks on the media product, as well as other associated information.

In one typical scenario, a user of computer 114 inserts an audio CD into media reader 115. An embodiment of the present invention identifies the inserted audio CD by calculating one or more identifiers, connecting to a server 104 and searching records in the recorded media DB 106 using the calculated identifier. Information in the identified database record is transmitted back to computer 114 and used to enhance the experience of the user of computer 114 using the audio CD.

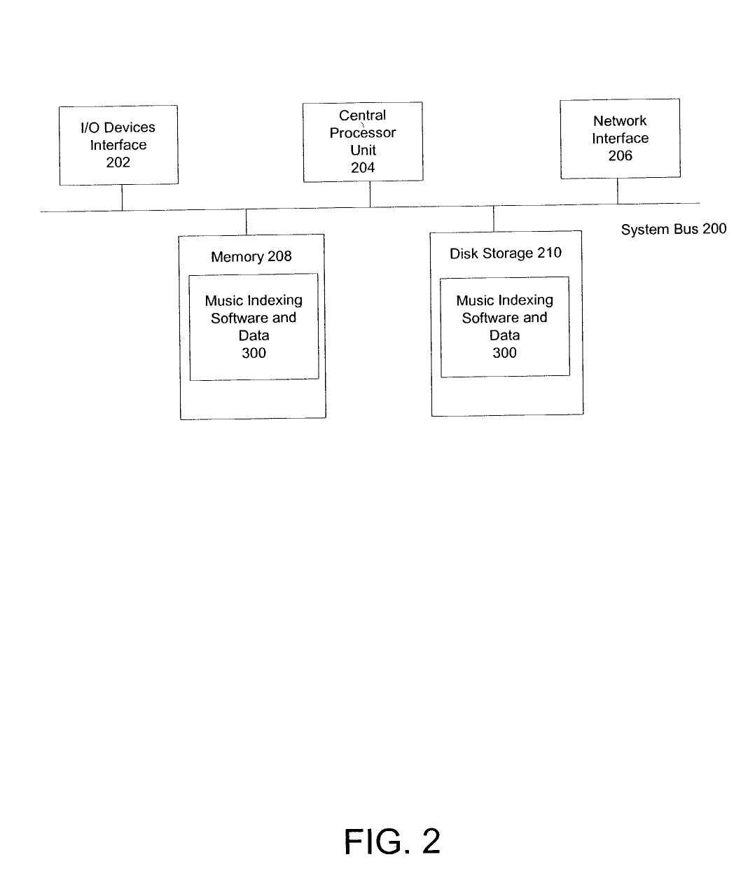

FIG. 2 is a diagram of the internal structure of a node 102, 104, 114, 116 connected to the networked system of FIG. 1 configured according to an embodiment of the present invention. Computers 114, 116 and servers 102, 104 contain a system bus 200; a bus is a set of hardware lines used for data transfer among the various components of a node connected to network 100. A bus is essentially a shared channel that connects different components of the node (e.g., I/O devices, processors, network interfaces, disk storage and memory) and enables the different components to transfer information. Attached to system bus 200 is I/O devices interface 202, which allows input and output devices, such as video displays, keyboards, speakers, pointing devices and the like to communicate with other components on system bus 200. A digital processor, such as central processor unit 204, executes instructions and accesses data stored in memory 208. Network interface 206 provides a link to an external network, for example network 100, thus allowing nodes to communicate with each other. Memory 208 stores computer software instructions and data structures used to implement an embodiment of the present invention (e.g., music indexing software and data 300). Disk storage 210 provides non-volatile storage for nodes on network 100 to store instructions and data, for example, music indexing software and data 300. The combination of components connected to system bus 200 provide for calculating a media identifier and indexing into a recorded media DB 106 using the calculated media identifier.

Music indexing software and data 300 provide instructions and data that calculate a media identifier and index into a recorded media database (e.g., recorded media DB 106) using the calculated media identifier.

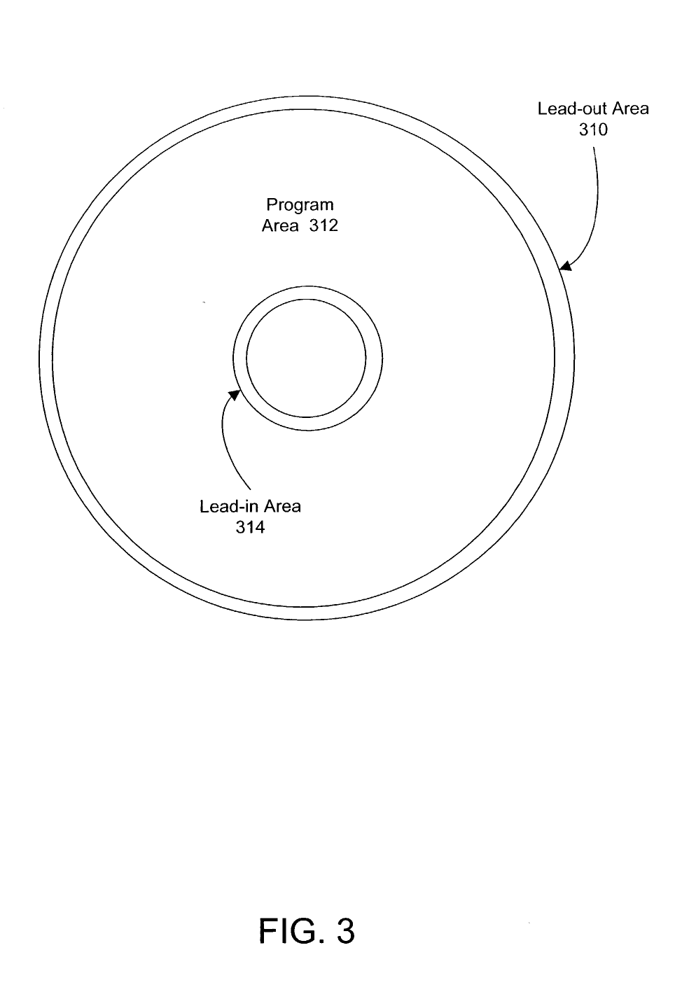

FIG. 3 is a diagram of the layout of an audio CD configured according to an embodiment of the present invention. An audio CD is laid out in tracks. The tracks are organized into various areas including a lead-out area 310, a program area 312 and a lead-in area 314. The program area 312 is the main data channel for the CD and typically contains audio or other data. The layout of CDs includes subcodes. Subcodes are included as a way of placing control data on a CD. Each subcode has channels defined within it. The lead-in area 314 has a Q-channel defined that contains a table of contents (“TOC”). The TOC comprises absolute times for the start of each track. These start times allow access on a track-by-track basis, allowing fast random access to tracks and features such as track shuffle. The TOC comprises the timecode for each track (as minutes, seconds and frames). The last timecode, defined as hexadecimal AA defines the start of the lead out (e.g., lead-out area 310). The lead-in area 314 must be long enough to store the TOC for 99 tracks. In addition the TOC defines a track type (e.g., audio or data).

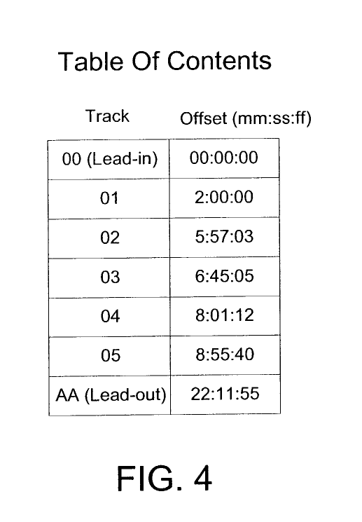

FIG. 4 illustrates a Table of Contents (TOC) for an audio CD configured according to an embodiment of the present invention. The TOC lists each track, including lead-in area 314 and the lead-out area 310. Each track has an associated offset. The offset is the absolute start time of the track. Offsets are defined as timecodes. A timecode defines the start time using minutes, seconds and frames (mm:ss:ff). A CD frame is defined as 1/75 of a second. In the example of FIG. 4, there are five program tracks defined (tracks 01-05), a lead-in track (00) and a lead-out track (AA). Each track has an associated offset (start time) indicated in mm:ss:ff format.

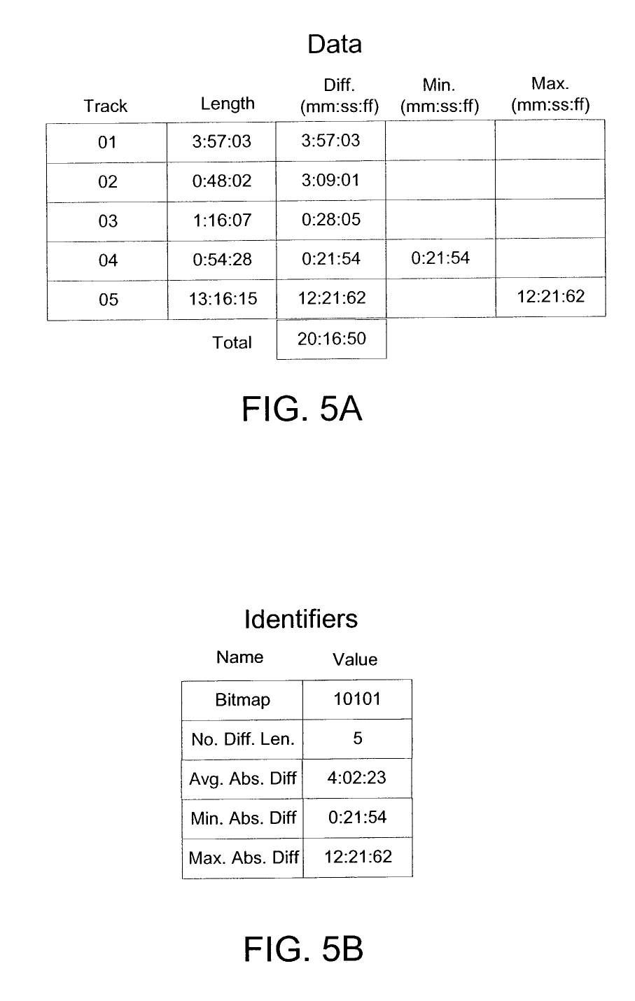

FIG. 5A is a table of data for example tracks stored on the CD of FIG. 4 configured according to an embodiment of the present invention. The table shows each program track (01-05) and its associated length, difference in length from the previous track, total of differences in lengths and the minimum and maximum length of tracks. This data is calculated from the TOC entries (of FIG. 4) and is used as the basis for creating various media identifiers.

FIG. 5B is a table of identifiers calculated for the example CD of FIG. 4 and FIG. 5A configured according to an embodiment of the present invention. Five different media identifiers are listed. The media identifiers can be used stand-alone, or in various combinations to identify the media in the media player (e.g., media player 115).

The bitmap media identifier is the result of a pair-wise comparison of track lengths (for example, the track lengths stored in the data table of FIG. 5A). In this example previous adjacent tracks are compared to a current track to produce a one-bit (“1”) or a zero-bit (“0”). A one-bit indicates that the current track is longer that its immediate previous adjacent track. A zero-bit indicates that the current track is shorter or equal to the preceding track. Tracks are identified by their bit-wise position in the bitmap. In one embodiment the track count starts at one and increases by one in a left to right direction. In the example track, as comparisons of the “Length” column of corresponding data table (FIG. 5A) reveals, track 01 is longer than track 00. Thus, the leading bit in the bitmap identifier is value 1, i.e., a 1-bit. Track 02 is shorter than track 01. Thus the second most significant bit in the bitmap identifier is value 0, i.e., a 0-bit. Track 03 is longer than track 02, thus the middle bit in the bitmap identifier is a one-bit. Track 04 is shorter than track 03 and track 05 is longer than track 04. Thus the last two bits in the bitmap identifier are “01”. The bitmap identifier 10101 results.

An additional identifier is No. Diff. Len. which is a calculation of the number of tracks with differing (unique) lengths. Using the “Length” column in FIG. 5A's data table, there are 5 unique lengths recorded. Thus, the No. Diff. Len. Identifier in FIG. 5B is assigned a value of 5.

The Avg. Abs. Diff. identifier (FIG. 5B) reports the average absolute difference between tracks. This is calculated by dividing the total of the differences (20:16:50) in the data table of FIG. 5A by the number of tracks (5). An Avg. Abs. Diff. identifier of (4:02:23) results.

The Min. Abs. Diff. identifier reports the minimum absolute difference between tracks. This is calculated by taking the minimum length from list of tracks lengths from the “Length” column of FIG. 5A (0:21:54).

The Max. Abs. Diff. identifier reports the maximum absolute difference between tracks. This is calculated by taking the maximum length from list of tracks lengths from the “Length” column of FIG. 5A (12:21:62).

These identifiers and various combinations of these identifiers are used to index records in a media products database (e.g., recorded media DB 106).

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for creating a media identifier, comprising the steps of:
reading a media comprising tracks and a table of contents, the table of contents comprising a track length for each of the tracks; and
calculating a string of symbols comprising one symbol representing the length of each track relative to an arithmetic or logical operation on one or more tracks contained within the media.

2. The method of claim 1 wherein the media is an audio CD or other recording comprising a sequence of tracks.

3. The method of claim 1 wherein a symbol in the string of symbols represents the relative length of a current track to the product of an operation on one or more tracks contained within the media.

4. A method for creating a media identifier, comprising the steps of:
reading the media comprising tracks and a table of contents, the table of contents comprising a beginning track offset for each of the tracks; and
calculating an identifier by determining an arithmetic metric of the difference of lengths of the tracks recorded on the media.

5. The method of claim 4 wherein the arithmetic metric is one of: average absolute difference, standard deviation of track length, or average square of differences.

6. The method of claim 4 wherein the arithmetic metric further determines a total number of tracks with differing lengths.

7. The method of claim 4 wherein the arithmetic metric further determines minimum differences of lengths of the tracks recorded on the media.

8. The method of claim 7 wherein the arithmetic metric is the minimum absolute differences of lengths.

9. The method of claim 4 wherein the arithmetic metric further determines maximum differences of lengths of tracks recorded on the media.

10. The method of claim 9 wherein the arithmetic metric is the maximum absolute differences of lengths.

11. A method of using a media identifier to index a database of records containing information about recorded media products, the recorded media products comprising tracks and a table of contents, the method comprising the steps of:
using the media identifier to identify a subset of records in the database; and
searching the identified records for a most likely match of media identifier to database record.

12. The method of claim 11 wherein the media identifier is calculated as a string of symbols comprising one symbol representing the length of each track relative to an arithmetic or logical operation on one or more tracks contained within the media.

13. The method of claim 11 wherein the media identifier is calculated by determining an arithmetic metric of the difference of lengths of the tracks recorded on the media.
